(19) United States
(12) Patent Application Publication
(10) Pub. No.: US 2024/0246624 A1
(43) Pub. Date: Jul. 25, 2024

(54) MODULAR COMPACT TRAILER

(71) Applicant: Compact Utility Trailers, LLC, Mohave, AZ (US)

(72) Inventor: Greg Squires, Mohave, AZ (US)

(21) Appl. No.: 18/297,275

(22) Filed: Apr. 7, 2023

Related U.S. Application Data
(60) Provisional application No. 63/481,357, filed on Jan. 24, 2023.

(51) Int. Cl. B62D 63/06; B60B 35/00; B60D 1/52; B60S 9/04; B62D 33/03; B62D 63/08

(52) U.S. Cl. CPC B62D 63/061; B60B 35/005; B60D 1/52; B60S 9/04; B62D 33/03; B62D 63/062; B62D 63/08

(57) ABSTRACT

A modular compact trailer for a utility terrain vehicle or an all-terrain vehicle that includes a trailer frame with a bed and a plurality of walls, at least two axle retention boxes, at least two axles, and a tongue. The at least two axles that are removably couplable to a corresponding axle retention box. The tongue is removably couplable to a front end of the trailer. The modular compact trailer includes a storage configuration in which the trailer frame is upright with components stored within the trailer frame. The modular compact trailer includes a transportation configuration in which the trailer frame fits within a bed of a standard truck bed with components stored within the trailer frame. The modular compact trailer includes an assembled configuration, the at least two axles are attached to the corresponding axle retention box and the tongue is attached to the front end of the trailer.

### RELATED CASES

This application claims priority to U.S. Provisional Application No. 63/481,357, filed on Jan. 24, 2023 and titled “MODULAR COMPACT TRAILER,” which is hereby incorporated by reference in its entirety.

### TECHNICAL FIELD

The present disclosure relates generally to the field of trailers for a utility terrain vehicle (UTV) and/or an all-terrain vehicle (ATV). More particularly, some embodiments relate to compact trailers that are modular and are configured to be disassembled into a compact storage configuration, a transportation configuration, and/or an assembled configuration.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a perspective view of a modular compact trailer for a UTV or a ATV according to one embodiment of the present disclosure.

FIG. 2 is a perspective view of a modular compact trailer in a storage configuration according to one embodiment of the present disclosure.

FIG. 3 is a perspective view of a modular compact trailer in a transportation configuration with the modular compact trailer stored in a bed of a pickup truck according to one embodiment of the present disclosure.

FIG. 4 is a bottom perspective view of a modular compact trailer with two axle retention boxes for receiving removably couplable axles according to one embodiment of the present disclosure.

FIG. 5 illustrates a detailed perspective view of one of the axle retention boxes of the modular compact trailer of FIG. 4.

FIG. 6 illustrates a detailed perspective view of the axle retention boxes of the modular compact trailer of FIG. 4 with an axle installed into one of the axle retention boxes.

FIG. 7 illustrates a front view of a modular compact trailer with a pin system for attaching accessories to the modular compact trailer according to one embodiment of the present disclosure.

FIG. 8 illustrates installing a lateral load bar to a modular compact trailer using a pin system according to one embodiment of the present disclosure.

FIG. 9 illustrates installing the lateral load bar of FIG. 8 to the modular compact trailer using the pin system with a pin partially inserted.

FIG. 10 illustrates installing the lateral load bar of FIGS. 8 and 9 to the modular compact trailer using the pin system with the pin fully installed and secured.

FIG. 11 illustrates a game tree accessory for a modular compact trailer according to one embodiment of the present disclosure.

FIG. 12 illustrates a stabilizing leg of a modular compact trailer according to one embodiment of the present disclosure.

FIG. 13 illustrates a pin locking system of the game tree accessory of FIG. 11 according to one embodiment of the present disclosure.

FIG. 14 illustrates locking the game tree accessory using the pin locking system of FIG. 13.

FIG. 15 illustrates the game tree accessory locked using the pin locking system of FIG. 13.

FIG. 16 illustrates a modular compact trailer according to one embodiment of the present disclosure.

### DETAILED DESCRIPTION

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

The phrase “coupled to” is broad enough to refer to any suitable coupling or other form of interaction between two or more entities, including mechanical. Thus, two components may be coupled to each other even though they are not in direct contact with each other. The phrases “attached to” or “attached directly to” refer to interaction between two or more entities which are in direct contact with each other and/or are separated from each other only by a fastener of any suitable variety (e.g., mounting hardware).

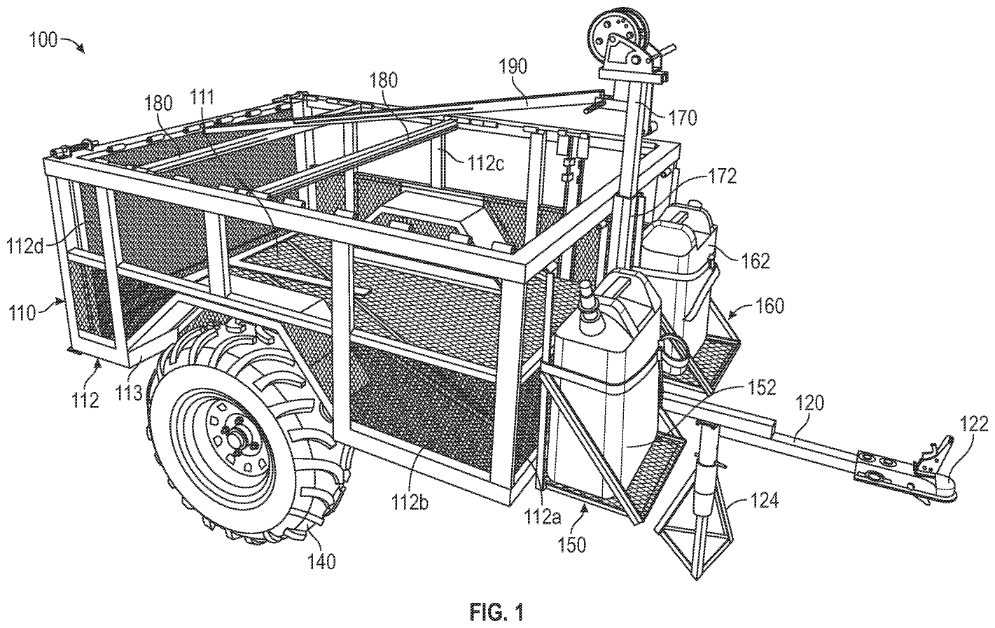

FIG. 1 illustrates a perspective view of a modular compact trailer 100 for an utility terrain vehicle (UTV) and/or an all-terrain vehicle (ATV) according to one embodiment of the present disclosure. The modular compact trailer 100 may be used by farmers, ranchers, outdoor enthusiasts, and the like.

FIG. 1 illustrates the modular compact trailer 100 in an assembled configuration. The modular compact trailer 100 is configured to be disassembled into a storage configuration and a transportation configuration. The various different configurations of the modular compact trailer 100 enables the modular compact trailer 100 to be used in a number of different situations. Specifically, the modular compact trailer 100 is designed to fit in a bed of a standard pickup truck so that the modular compact trailer 100 can be easily transported from one location to another location. Accordingly, the modular compact trailer 100 can be transported in the bed of the pickup truck rather than having a first trailer for the modular compact trailer 100 and a second trailer for the UTV or ATV which tows the modular compact trailer 100. This will be discussed in further detail below.

In addition, the design of the storage configuration of the modular compact trailer 100 enables the modular compact trailer 100 to be stored compactly due to the small footprint of the modular compact trailer 100. Therefore, the modular compact trailer 100 can be stored in a garage, a shed, or another place where the use of space is at a premium. This will be discussed in further detail below.

The modular compact trailer 100 may be quickly and easily assembled into the assembled configuration from either the storage configuration or the transportation configuration. The ease of assembly and disassembly is another benefit of the modular compact trailer 100.

Further, the design of the modular compact trailer 100 enables a variety of different accessories to be attached to the modular compact trailer 100. The different accessories allow a user to customize the modular compact trailer 100 based on the current specific use for the modular compact trailer 100. The modular compact trailer 100 may then be customized again with different accessories for another specific use. The modular compact trailer 100 includes a pin system that allows for easy and quick attachment of the accessories to the modular compact trailer 100. This will be discussed in further detail below.

Due to the modular nature of the modular compact trailer 100, the user may customized the modular compact trailer to meet their specific needs. For example, axles, wheels, and other features may be switched during either manufacture or after manufacture to meet different needs of different users or to meet different needs of the same user. This will be discussed in further detail below.

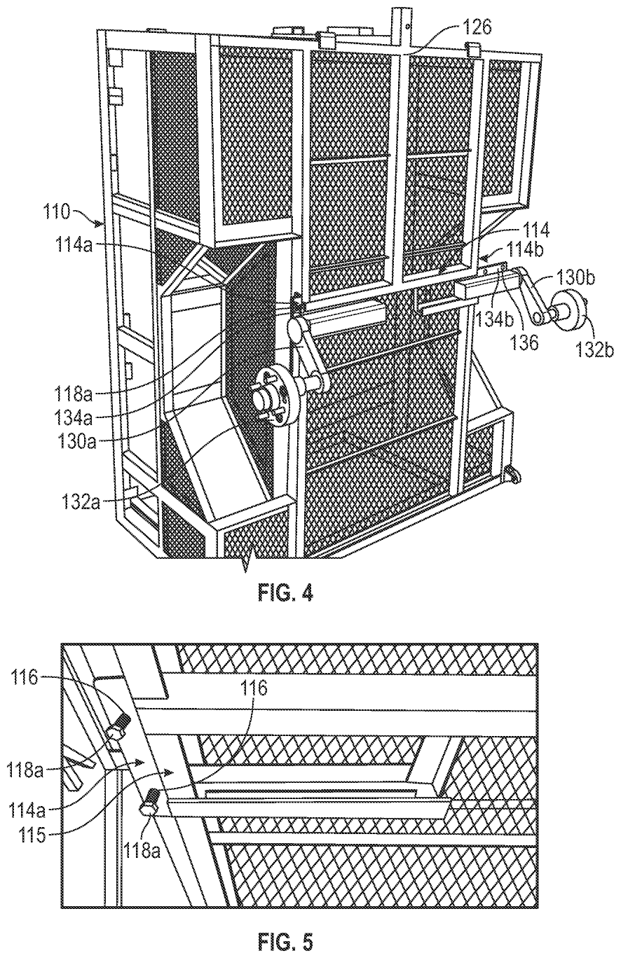

The modular compact trailer 100 comprises a number of different components. In the illustrated embodiment of FIG. 1, the modular compact trailer 100 includes a trailer frame 110, a tongue 120 that is removably couplable to the trailer frame 110, a pair of axles 130 (see FIG. 4) that are removably couplable to the trailer frame 110, and a pair of wheels 140 that are removably couplable to the pair of axles 130. While the illustrated embodiment illustrates two axles 130 and two wheels 140, the present disclosure is not so limited. The modular compact trailer 100 may have two, four, or more axles and wheels.

The trailer frame 110 comprises a bed 111 and a plurality of walls 112 that surround the bed 111. The walls 112 includes a front wall 112a, a first lateral wall 112b, a second lateral wall 112c, and a rear wall of tailgate 112d. The walls 112 may be solid, may comprise a metal mesh, or may include a plurality of open sections with framing around the open sections. A width of the trailer frame 110 may be four feet and a height of the trailer frame 110 may be two feet. The length of the trailer frame 110 may be between three feet and eight feet.

The tailgate 112d may be a standard tailgate in that the tailgate 112d is hingedly coupled to the bed 111 of the trailer frame 110 such that the tailgate 112d of the modular compact trailer 100 folds down to provide access to the bed 111 of the trailer frame 110. In some embodiments, the tailgate 112d may be a dump style tailgate that enables the contents of the bed 111 to be dumped by inclining the angle of the bed 111 and the trailer frame 110. In some embodiments, the tailgate 112d may be a mesh tailgate or a cargo net that is a fabric that reduces the weight of the tailgate 112d and improves air flow through the tailgate 112d during use to reduce drag. In some embodiments, the tailgate 112d may be removably attachable from the trailer frame 110.

In some embodiments, the trailer frame 110 includes wheel wells 113. The wheel wells 113 are configured to receive the wheels 140 and are located near the axles 130. The wheel wells 113 extend into the bed 111 of the trailer frame 110 and ensure that the wheels 140 do not extend or only extend a little bit beyond the lateral edges of the first lateral wall 112b and the second lateral wall 112c.

The trailer frame 110 may have a solid main frame construction made from all welded steel components. In some embodiments, the trailer frame 110 may be made from all welded aluminum components.

The tongue 120 is removably couplable to the trailer frame 110. The tongue 120 includes a coupler 122 to enables the modular compact trailer 100 to be secure to a trailer hitch of the UTV or ATV. Accordingly, the UTV or ATV is able to tow the modular compact trailer 100 for various uses. An end of the tongue 120 opposite of the coupler 122 may be removably couplable to the front wall 112a of the trailer frame 110. The trailer frame 110 may have a hollow structural section 126 (see FIG. 4) sized to receive the tongue 120 and the tongue 120 may be secured by a fastener, such as a bolt. In other words, the tongue fits within the hollow structural section 126. The modular compact trailer 100 may include a stand 124 to stabilize the modular compact trailer 100 when not attached to the UTV or ATV. The stand 124 may include a jack to raise and lower the tongue to help attached the coupler 122 of the tongue 120 to the trailer hitch of the UTV or ATV.

As will discussed more below, the pair of axles 130 are removably couplable to the trailer frame 110 and the wheels 140 are removably couplable to the axles 130. In other words, each wheel 140 is removably couplable to a corresponding axle 130 which is removably couplable to the trailer frame 110.

The modular compact trailer 100 may further comprise a plurality of accessories that are removably couplable to the trailer frame 110. The user may utilize specific accessories for different reasons. In the illustrated embodiment, the modular compact trailer 100 has a plurality of accessories coupled to the trailer frame 110. For example, a first shelf 150 and a second shelf 160 are removably couplable to the front wall 112a of the trailer frame 110. The first shelf 150 may hold a fuel container 152 for the UTV or ATV. The second shelf 160 may hold a water container 162. The fuel container 152 and the water container 162 may be secured with straps to the first shelf 150 and the second shelf 160 respectively.

Another accessory may be a winch 170 that is coupled to the front wall 112a of the trailer frame 110. In some embodiments, the winch 170 may be disposed within a hollow structural section 172 of the trailer frame 110 disposed above the tongue 120 attachment of the trailer frame 110. The winch 170 may be secured with a fastener, such as bolt, within the hollow structural section 172. In some embodiments, the winch 170 may be received into the hollow structural section 126 for the tongue 120.

Another accessory may be a lateral load bar 180 that extends from the first lateral wall 112b to the second lateral wall 112c. The lateral load bar 180 may be used to secure a load within the bed 111 of the trailer frame 110. The illustrated embodiment of FIG. 1 illustrates two lateral load bars 180, but the modular compact trailer 100 may have fewer or more lateral load bars 180. Another accessory may be a longitudinal load bar 190 that extends from the winch 170 (or the front wall 112a) to the tailgate 112d.

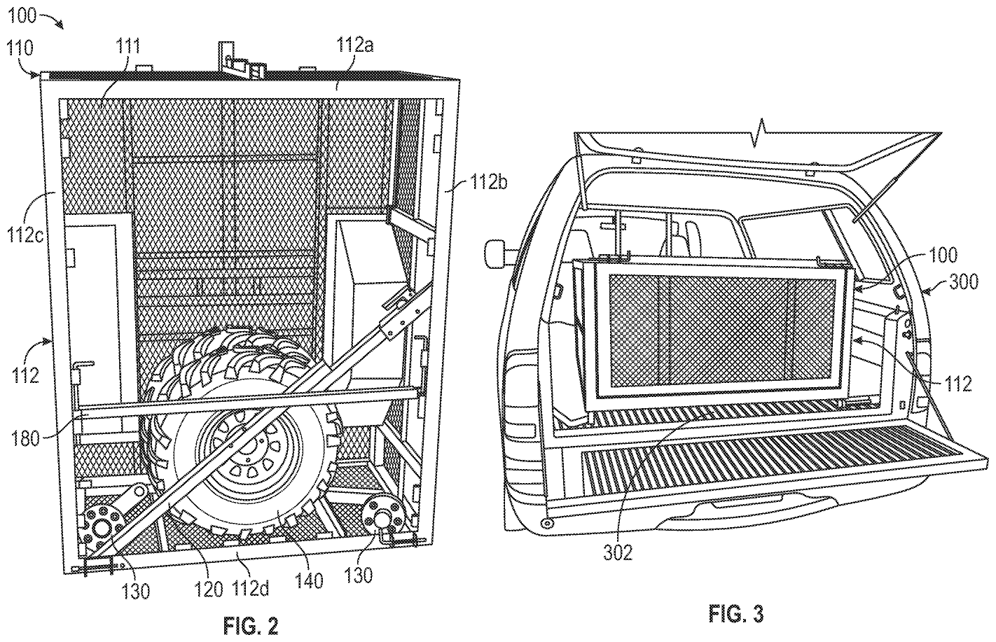

The modular nature of the modular compact trailer 100 enables of user to disassemble the modular compact trailer 100 for storage and for transportation. FIG. 2 illustrates the modular compact trailer 100 in the storage configuration. The tongue 120, the axles 130, the wheel 140, and any accessories are removed from the trailer frame 110 and may be stored within confines of the modular compact trailer 100. In other words, the components are storable within the bed 111 and the surrounding walls 112.

Essentially, the modular compact trailer 100 is disassembled into the trailer frame 110 with all of other components stored within the trailer frame 110.

In the illustrated embodiment, the modular compact trailer 100 is stored with the trailer frame 110 in an upright or vertical position with all of the components stored within. The lateral load bar 180 may be used to help secure the components within the trailer frame 110, especially the tongue 120 and the wheels 140. The trailer frame 110 in the upright storage configuration has a small footprint. The footprint of the trailer frame 110 is two feet by four feet. The height of the trailer frame 110 depends on the length of the trailer frame 110, somewhere between three feet and eight feet. The tailgate 112d does not have any protrusions or protuberances so that the trailer frame 110 can firmly stand upright providing a sturdy base. The small footprint allows the modular compact trailer 100 to be stored in tight places, such as garages, sheds, and the like. The modular compact trailer 100 is not limited to being stored in the upright storage configuration, but this configuration provides the smallest footprint for storage.

FIG. 3 illustrates the modular compact trailer 100 in the transportation configuration with the tongue 120, the axles 130, the wheel 140, and any accessories removed from the trailer frame 110 and stored within confines of the modular compact trailer 100. In other words, the components are stored within the bed 111 and the surrounding walls 112. The modular compact trailer 100 is designed to fit within a bed 302 of a standard pickup truck 300. The modular compact trailer 100 in the transportation configuration has a footprint of four feet by the length of the trailer frame 110, between three feet and eight feet. The transportation configuration allows for transporting the modular compact trailer 100 within the confines of a standard truck's fender wells without needing a separate trailer for the modular compact trailer 100.

FIG. 4 illustrates a bottom perspective view of the trailer frame 110. The bottom of the trailer frame 110 comprise a pair of axle retention boxes 114 that allows for easy and quick exchange of the axles 130 with the pair of axle retention boxes 114. The axle retention boxes 114 are sized to receive a corresponding axle 130. The axles retention boxes 114 includes a first axle retention box 114a and a second axle retention box 114b. As illustrates in FIG. 4, the first axle retention box 114a has a first axle 130a installed and the second axle retention box 114b has a second axle 130b partially installed. Each axle 130 includes an adapter 132a, 132b for attaching the wheels 140 to the axles 130a, 130b. The adapters 132a, 132b may have a 4×4.25 lug pattern, a 4×110 mm lug pattern as these adapters fit most common wheel size. Other adapters can contemplated by this disclosure. In some embodiments, the user can change out the adapters for their needs as UTC/ATV wheels can have different patterns depending on the manufacture and models. The adapters 132a, 132b may allow for any wheel configuration to work with a size no greater than 32 inches in diameter. The modular compact trailer 100 may be equipped with ATV/UTV tires and wheels. The adapters 132a, 132b can be fitted to match any UTV tire on the market, thus provide the need for only one spare tire that matches the towing vehicle (ATV/UTV) as well as the modular compact trailer 100.

Each axle 130 comprises a plate 134a, 134b for attaching the axle 130 to a vehicle or trailer. The plate 134 may comprise a plurality of apertures 136a, 136b for receiving fasteners to secure the axle 130 to the vehicle or trailer. The axles 130a, 130b may be a stub torsion axle. The use of stub torsion axles gives the modular compact trailer 100 an independent suspension and the capability of upgrading to different weight capacity axle groups. In some embodiments, the modular compact trailer 100 may have a straight axle group without suspension. The axles 130a, 130b may also be 1 ton axles, 2 ton axles, or 3 ton axles based on the specific needs of the user. By using this type of tire and wheel system, it allows the user to choose the independent axle suspension and its shock absorbing suspension or the straight axle group for lower costs while still having control of a suspension via tire pressure.

FIG. 5 is a detailed view of the first axle retention box 114a. Each axle retention box 114 comprises a slot 115 to receive the plate 134a, 133b of the axle 130a 130b. Each axle retention box 114a, 114b comprises two corresponding apertures 116a that align with two of the apertures 136 of the plate 134. When the plate 134a is slid within the slot 115, fasteners 118a secure the axle 130 to the axle retention box 114. The design allows easy and quick exchange or removal of the axles 130 via two fasteners, such as the two bolts illustrated in FIG. 5.

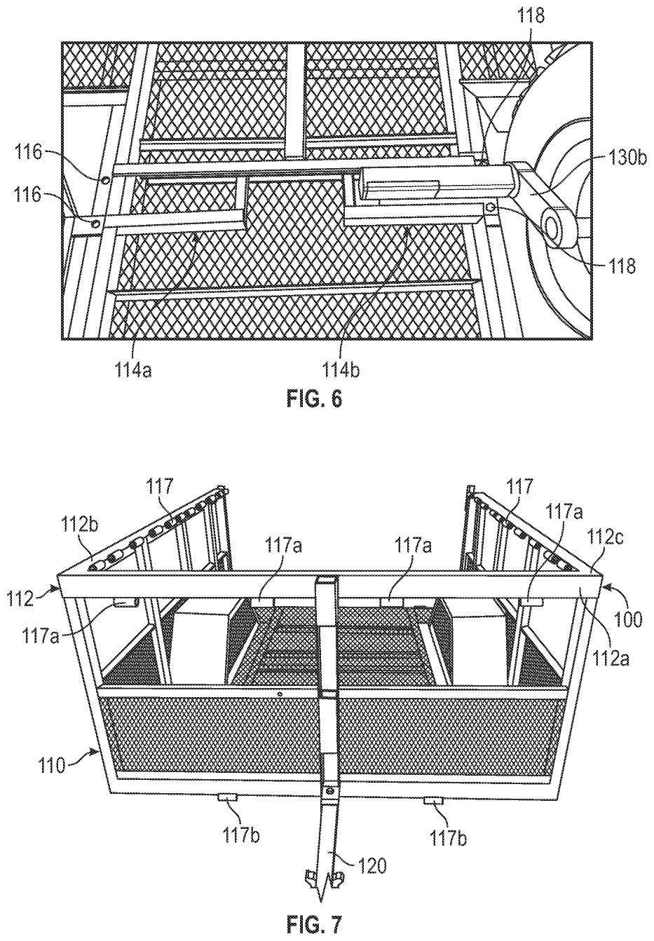

FIG. 6 is a detailed view of two axle retention boxes 114a, 114b with the second axle 130b attached to the second axle retention box 114b with two fasteners 118, such as the two illustrated bolts. The first axle retention box 114a illustrates the apertures 116.

FIG. 7 illustrates a front perspective view of the modular compact trailer 100. The modular compact trailer 100 includes a pin system for attaching accessories to the modular compact trailer 100. The trailer frame 110 includes a plurality of loops 117 that are attached to or welded to the trailer frame 110. The plurality of loops 117 may be coupled to an inner perimeter of the walls 112 of the trailer frame 110. The illustrated embodiment of FIGS. 1 and 7 depicts the loops 117 coupled to the first lateral wall 112b, the second lateral wall 112c, and the tailgate 112d. While FIGS. 1 and 7 do not depict loops 117 on the inner perimeter of the front wall 112a, the inner perimeter of the front wall 112a may include loops 117. FIG. 7 depicts loops 117a disposed on near a top of an outer perimeter of the front wall 112a and loops 117b at a bottom of the front wall 112a.

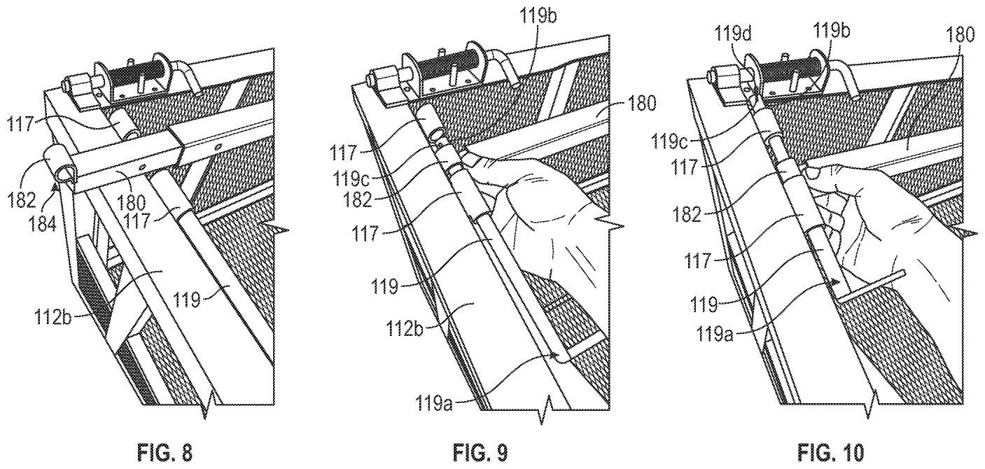

FIGS. 8-10 illustrate the process of using the pin system to attach an accessory. The pin system allows for expansion of the modular compact trailer with a variety of accessories, as discussed above, accessories include the first shelf 150, the second shelf 160, the lateral load bars 180, the longitudinal load bar 190, and the like. Other potential accessories include stove attachments, side worktables, garage wheels, and the like.

FIG. 8 illustrates the process of using the pin system to couple the lateral load bar 180 to the first lateral wall 112b. The same system may be used to removably attach other accessories to the loops 117 of the trailer frame 110. The lateral load bar 180 may comprise a loop 182 disposed at a first end 184 of the lateral load bar 180. The opposing end (not shown) may also include a loop. The loop 182 may be disposed between two adjacent loops 117 of the first lateral wall 112b, each loop 117, 182 is configured to receive a pin 119.

FIG. 9 illustrates the pin 119 sliding through one of the loops 117 and the loop 182 of the lateral load bar 180. FIG. 10 illustrates the pin 119 sliding through both of the loops 117 of the first lateral wall 112b and the loop 182 of the lateral load bar 180 to secure the lateral load bar 180 to the first lateral wall 112b of the trailer frame 110. A first end 119a of the pin 119 may be bigger than the loop 117 so that the first end 119a of the pin 119 cannot enter the loop 117. A second end 119b of the pin 119 may comprise an aperture 119c for a cotter pin 119d so that the lateral load bar 180 may be secured to the first lateral wall 112b. The cotter pin 119d may be removed by a user to release the pin 119. The opposing end of the lateral load bar 180 may be secured to the second lateral wall 112c in a similar manner.

The first shelf 150 and the second shelf 160 may also be attached to the modular compact trailer 100 using the loops 117a, 117b disposed on an outer surface of the front wall 112a. As illustrated in FIG. 7, a left side of the front wall 112a includes two top loops 117a and one bottom loop 117b (see FIG. 7). The first shelf 150 may comprise three pins to connect the first shelf to the loops 117a, 117b. The first shelf 150 includes two pins on the top and one pin on the bottom that are welded to the first shelf. Each pin in configured to engage with and slide into a corresponding loop 117a, 117b. The pins may have differing lengths so that the user may align one pin at a time with a corresponding loop. For example, a top pin have be the longest and it aligns with its corresponding top loop 117a first. The bottom pin may be the next longest and it aligns with the corresponding bottom loop 117b next. The other top pin is shortest and aligns with its corresponding top loop 117a last. A cotter pin may be inserted into a aperture of the longest pin to secure the first shelf to the front wall 112a of the trailer frame 110. The second shelf 160 may be installed in a similar manner. A location of differing length pins may be rearranged.

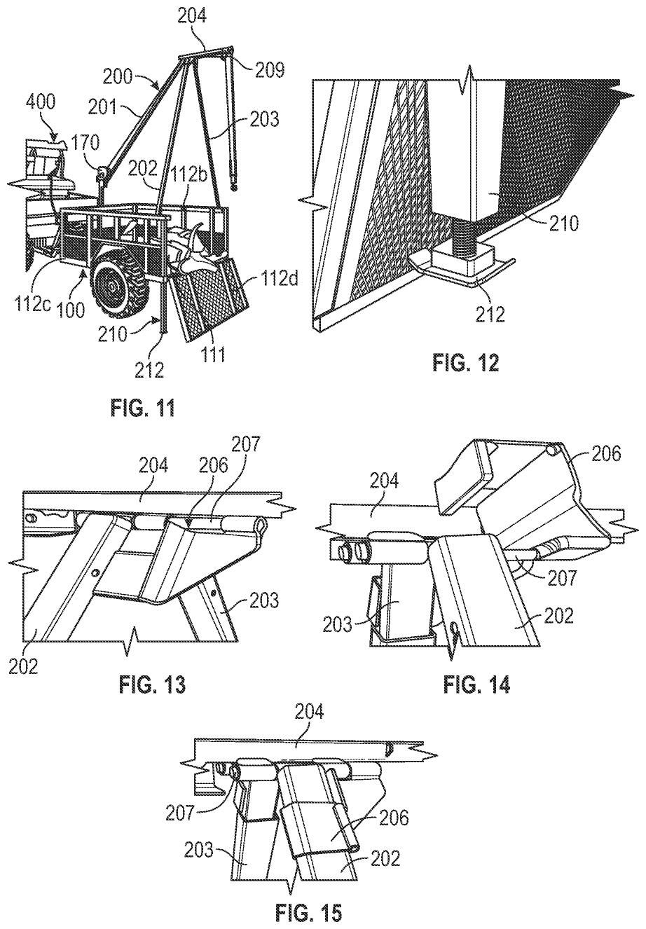

FIG. 11 illustrates the modular compact trailer 100 coupled to a UTV/ATV 400 in the assembled configuration with a game tree accessory 200. The game tree accessory 200 is removably couplable to the modular compact trailer 100. The game tree accessory 200 may be used by hunters to hoist game into the bed 111 of the modular compact trailer 100. The tailgate 112d is lowered and a pair of adjustable stabilizing legs 210 are lowered to stabilize the modular compact trailer 100.

The game tree accessory 200 comprises a first support 201 that is removably couplable to the winch 170, a second support 202 removably couplable to a first lateral wall 112b of the trailer frame 110, and a third support 203 removably couplable to a tailgate 112d of the trailer frame 110. The first support 201, the second support 202, and the third support 203 may be coupled to the walls 112 using the pin system discussed above. The first support 201, the second support 202, and the third support 203 are coupable together above the trailer frame 110 with a pin locking system 206. The game tree accessory 200 further comprises a fourth support 204 above the trailer frame 110 that extends from the coupling of the first support 201, the second support 202, and the third support 203 beyond a rear of the modular compact trailer 100. The fourth support 204 comprises a pulley 209 that works in conjunction with the winch 170.

FIG. 12 shows a detailed view of one of the adjustable stabilizer legs of FIG. 11. The modular compact trailer 100 may have two stabilizing legs 210 disposed at opposing rear corners of the modular compact trailer 100. Each of the stabilizing legs 210 is extendable from the bed 111 of the trailer frame 110 to the ground when the modular compact trailer 100 is in the assembled configuration. Each of the stabilizing legs 210 may be retractable into the trailer frame 110. In some embodiments, the pair of stabilizing legs 210 telescope within corresponding hollow structural sections of the trailer frame 110 disposed in the rear corners of the trailer frame 110. Each stabilizing leg 210 may comprise a foot 212 that is independently adjustable from the length of the stabilizing leg 210. The foot 212 is attached by a screw. The length of the adjustable stabilizing leg 210 allows for course adjustment and the foot 212 allows for fine adjustable.

FIGS. 13-15 illustrates a pin locking system 206 for securing the second support 202 to the fourth support 204. An additional pin locking system 206 may be used to secure the third support 203 to the fourth support 204. FIGS. 13-15 illustrate the securement of the second support 202 to the fourth support 204. FIG. 13 illustrates the apex of the game tree accessory 200 in an unsecured configuration between the second support 202 and the fourth support 204. FIG. 14 illustrates a pin 207 of the pin locking system 206 sliding through a loop 208 of the fourth support 204 at the apex of the game tree accessory 200. FIG. 15 illustrates pin locking system 206 locked in place around the second support 202 to secure the second support 202 to the fourth support 204. The third support 203 may be secured to the fourth support 204 in a similar manner.

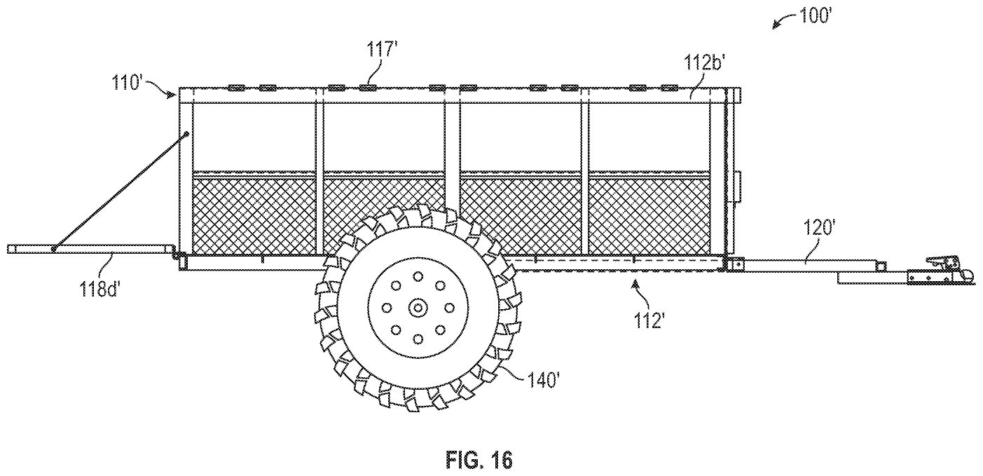

FIG. 16 depicts an embodiment of a modular compact trailer 100′ that resembles the modular compact trailer 100 described above in certain respects. Accordingly, like features are designated with like reference numerals with an additional apostrophe. For example, the embodiment depicted in FIG. 16 includes a trailer frame 110′ that may, in some respects, resemble the trailer frame 110 of FIGS. 1-15. Relevant disclosure set forth above regarding similarly identified features thus may not be repeated hereafter. Moreover, specific features of modular compact trailer 100 and related components shown in FIGS. 1-15 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the modular compact trailer 100′ and related components depicted in FIG. 16. Any suitable combination of the features, and variations of the same, described with respect to the modular compact trailer 100 and related components illustrated in FIGS. 1-15 can be employed with the modular compact trailer 100′ and related components of FIG. 16, and vice versa.

FIG. 16 illustrates a side view of the modular compact trailer 100′. The modular compact trailer 100′ includes a trailer frame 110 with walls 112′. FIG. 16 illustrates a first lateral wall 112b′ and a tailgate 112d′. Along the inner circumference of the first lateral wall 112b′ are a plurality of loops 117′ of a pin system. A tongue 120′ is removably couplable to the trailer frame 110′. The trailer frame 110′ does not include wheel wells at wheels 140′ are lateral to the lateral walls, e.g., the first lateral wall 112b′. The modular compact trailer 100′ is longer than the modular compact trailer 100 of FIG. 1. The modular compact trailer 100′ is also configured to have an assembled configuration, a storage configuration, and a transportation configuration. The trailer frame 110′ has a width of four feet and a height of the walls 112′ is two feet. The modular compact trailer 100′ has the same footprint as the modular compact trailer 100, two feet by four feet, but a different footprint as the modular compact trailer 100 in the transportation configuration, four feet by the length of the modular compact trailer 100′ because the modular compact trailer 100′ is longer than the modular compact trailer 100.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

We claim:

1. A modular compact trailer for a utility terrain vehicle or an all-terrain vehicle comprising:
a trailer frame including a bed with a plurality of walls surrounding the bed;
at least two axle retention boxes;
at least two axles, each axle configured to be removably couplable to a corresponding axle retention box of the at least two axle retention boxes;
a tongue that is removably couplable to a front end of the trailer,
wherein in a storage configuration the at least two axles and the tongue are storable within the trailer frame,
wherein in a transportation configuration, the trailer frame fits within a bed of a standard truck bed and the at least two axles and the tongue are storable within the trailer frame, and
wherein an assembled configuration, the at least two axles are attached to the corresponding axle retention box and the tongue is attached to the front end of the trailer.

2. The modular compact trailer of claim 1, wherein a width of the trailer frame is four feet.

3. The modular compact trailer of claim 1, wherein a height of the plurality of walls of the trailer frame is two feet.

4. The modular compact trailer of claim 1, wherein a length of the trailer is between three and eight feet.

5. The modular compact trailer of claim 1, further comprising at least two wheels attachable to the at least two axles, wherein the storage and transportation configurations, the at least two wheels are storable within the trailer frame, and wherein in the assembled configuration, the wheels are attached to a corresponding axle of the at least two axles.

6. The modular compact trailer of claim 1, wherein each axle retention box comprises a slot to receive the corresponding axle, wherein the corresponding axle slides into the slot and is secured to the corresponding axle retention box via a plurality of fasteners.

7. The modular compact trailer of claim 6, wherein the corresponding axle is secured to the corresponding axle retention box via two fasteners at an outer edge of the corresponding axle retention box.

8. The modular compact trailer of claim 1, further comprising a pair of stabilizing legs, wherein each stabilizing leg is disposed at opposing rear corners of the trailer frame, and wherein each stabilizing leg is extendable from the bed of the trailer frame to the ground when the modular compact trailer is in the assembled configuration and each stabilizing leg is retractable into the trailer frame.

9. The modular compact trailer of claim 8, wherein the pair of stabilizing legs telescope within corresponding hollow structural sections of the trailer frame disposed in the rear corners of the trailer frame.

10. The modular compact trailer of claim 1, further comprising a plurality of a trailer accessories that are removably couplable to the trailer frame, and wherein the plurality of trailer accessories are storable within the trailer frame in the storage and transportation configurations.

11. The modular compact trailer of claim 1, wherein a tailgate of the trailer frame is hingedly coupled to the bed of the trailer frame such that the tailgate of the trailer folds down to provide access to the bed of the trailer frame.

12. The modular compact trailer of claim 1, further comprising a pin system that comprises a plurality of loops that are coupled to an inner perimeter of the walls of the trailer frame, wherein a trailer accessory is attachable to the trailer frame by inserting a pin through the trailer accessory and at least two loops.

13. The modular compact trailer of claim 12, further comprising a load bar that extends from a first lateral wall to a second lateral wall of the trailer frame and is couplable to the first lateral wall and the second lateral wall via the pin system.

14. The modular compact trailer of claim 12, further comprising a side worktable that is couplable to one of the walls of the trailer frame using the pin system.

15. The modular compact trailer of claim 1, further comprising a pin system that comprises plurality of loops that are coupled to an outer perimeter of the walls of the trailer frame, wherein a trailer accessory is attachable to the trailer frame by inserting three different pins into three different loops of the plurality of loops.

16. The modular compact trailer of claim 15, wherein each pin of the three different pins of the trailer accessory have a different length.

17. The modular compact trailer of claim 1, further comprising a winch that is removably couplable to a front end of the trailer frame.

18. The modular compact trailer of claim 17, further comprising a game tree attachment that is removably couplable to the trailer frame, wherein the game tree attachment comprises a first support that is removably couplable to the winch, a second support removably couplable to a first lateral wall of the trailer frame, and a third support removably couplable to a second lateral wall of the trailer frame, wherein the first support, the second support, and the third support are coupable together above the trailer frame, wherein a fourth support extends from the coupling of the first support, the second support, and the third support beyond a rear of the trailer frame, and wherein the fourth support comprises a pulley that works in conjunction with the winch.
